(19) United States
(12) Patent Application Publication
(10) Pub. No.: US 2005/0175784 A1
(43) Pub. Date: Aug. 11, 2005

(54) Method of manufacturing fuel cell

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/046,767

(22) Filed: Feb. 1, 2005

(30) Foreign Application Priority Data
Feb. 10, 2004 (JP) 2004-033486

(51) Int. Cl. B05D 3/00

(52) U.S. Cl. 427/402

(57) ABSTRACT

Exemplary embodiments provide a method of manufacturing a fuel cell that includes a reaction layer, to which a catalyst is evenly applied, and that has high reaction efficiency, and which can be easily manufactured. A first gas passage is formed in a first substrate, which is conveyed by a belt conveyor that is driven by a drive unit according to a signal from a drive unit, at dischargers. At another discharger, a first current-collecting layer is then formed on the first substrate conveyed by the belt conveyor. At another discharger, a first reaction layer is formed by applying a catalytic solution several times to respectively different places. Then, an electrolyte membrane is formed in another discharger. In the same way, a second reaction layer is formed at another discharger and a second current-collecting layer is formed at another discharger. Finally, at other dischargers, a second substrate in which a second gas passage was formed is placed on a predetermined position of the first substrate and then the fuel cell is completed.

### BACKGROUND

Exemplary embodiments of the present invention relate to a method of manufacturing a fuel cell in which different reactive gases are externally supplied to respective electrodes and are reacted to generate electric power.

The related art includes a fuel cell having porous electrodes through which electrons pass, and an electrolyte through which ions pass between the electrodes. One such fuel cell includes is a fuel cell that uses, for example, hydrogen or alcohol, and the like to generate electric power. For example, in a fuel cell that uses the hydrogen as fuel, a first reactive gas including the hydrogen is supplied to one electrode and a second reactive gas including oxygen is supplied to the other electrode. The hydrogen that is contained in the first reactive gas reacts with the oxygen that is contained in the second reactive gas, and the electric power is generated by the reaction.

The fuel cell often has a reaction layer made of platinum that serves as a catalyst to promote the reaction. The reaction layer is made by rubbing or spraying a chloroplatinic solution, or a solution in which a platinum supported carbon is dispersed (see Japanese Unexamined Patent Publication No. 2002-298860).

### SUMMARY

In order to manufacture a fuel cell with a good or enhanced property and high reaction efficiency, it is necessary to form a reaction layer to which the catalyst is evenly applied. However, when the solution, in which the platinum supported carbon is dispersed, is misted by using a spray, it is difficult to apply the solution uniformly. Moreover, the expensive platinum may be unnecessarily over-applied. When platinum particles dispersed solution is redundantly applied by, for example, spraying it to the same place twice, a crystal of the platinum particle becomes too large in a process of, for example, firing in order to remove the dispersing agent. In this case, an overall area where the platinum particles contact with the reactive gas becomes small, and a problem arises in that it leads to degradation of the overall reaction efficiency of the fuel cell.

Exemplary embodiments to the present invention address the above-mentioned and/or problems, and to provide a method of manufacturing a fuel cell that includes a reaction layer, to which the catalyst is evenly applied, and that has the high reaction efficiency, and which can be easily manufactured.

A method of manufacturing a fuel cell of an exemplary embodiment of the present invention includes forming a first gas passage through which a first reactive gas is supplied on a first substrate, forming a first current-collecting layer that collects electrons produced by a reaction of the first reactive gas supplied through the first gas passage, and forming a first reaction layer that reacts according to the first reactive gas supplied through the first gas passage. The method further includes forming a second gas passage through which a second reactive gas is supplied on a second substrate, forming a second current-collecting layer that provides necessary electrons to react the second reactive gas supplied through the second gas passage, and forming a second reaction layer that reacts according to the second reactive gas supplied through the second gas passage. Further, in the above-described method, at least one of the first reaction layer and the second reaction layer is formed by using a discharger to apply a catalytic solution containing a catalyst material several times to respectively different places of the substrate.

According to the above-mentioned method of manufacturing a fuel cell, at least one of the first reaction layer and the second reaction layer is formed by using a discharger to apply a catalytic solution containing a catalyst material several times to respectively different places of the substrate. In this way, the catalytic solution can be evenly applied to the substrate, and a fuel cell with the high reaction efficiency can be manufactured.

The method may further include firstly applying the catalytic solution to the substrate, and secondly applying the catalytic solution to a position other than an area where the catalytic solution was firstly applied in order to form at least one of the first reaction layer and the second reaction layer.

According to the above-mentioned method, at least one of the first reaction layer and the second reaction layer is formed by applying the catalytic solution so as not to overlap the droplet that has been already applied on the substrate. This can discourage or prevent an amount of the catalytic solution applied to a unit area of the substrate from becoming unnecessarily large. Accordingly, the platinum particles are evenly dispersed. In other words, a small crystal of the platinum particle is dispersed in the unit area. Therefore, a fuel cell in which a reaction layer with the high reaction efficiency, and in which the platinum particles are evenly dispersed can be manufactured.

The method may further include firstly applying the catalytic solution to the substrate, drying the applied catalytic solution after the catalytic solution was firstly applied, and secondly applying the catalytic solution to the substrate after the drying in order to form at least one of the first reaction layer and the second reaction layer.

According to the above-mentioned method, at least one of the first reaction layer and the second reaction layer is formed by further applying the catalytic solution after drying the catalytic solution that had been applied. For example, when a catalytic solution with a high surface tension and a high evaporability is applied, adjacent droplets tend to bind each other and become a one large droplet. In this case, a crystal of the platinum particle is likely to grow large when a dispersant is removed. By performing drying between the applications of the catalytic solution, the reaction layer in which the catalyst is evenly dispersed can be formed, even when the catalytic solution with a high surface tension and a high evaporability is used. Therefore, the fuel cell with the high reaction efficiency can be easily manufactured.

The method may further include firstly applying a droplet of the catalytic solution to the substrate, and secondly applying a droplet of the catalytic solution that has a different size from the droplet firstly applied in order to form at least one of the first reaction layer and the second reaction layer.

According to the above-mentioned method, at least one of the first reaction layer and the second reaction layer is formed by applying a droplet of the catalytic solution that has a different size from the droplet firstly applied. For example, after a droplet of the catalytic solution is firstly applied to the substrate, a droplet that is smaller than that of the first application is applied to a blank space among the first droplets to form the reaction layer. In this way, the catalytic solution can be evenly applied without leaving any blank space on the substrate, and the fuel cell with the high reaction efficiency can be manufactured.

### BRIEF DESCRIPTION OF THE DRAWINGS

FIG. 1 is a schematic that shows an example of a fuel cell manufacturing line according to an exemplary embodiment of the present invention;

FIG. 2 is a schematic that shows a structure of an ink-jet discharger according to the exemplary embodiment;

FIG. 3 is a flow chart of a manufacturing method a fuel cell according to the exemplary embodiment;

FIGS. 4(a) and 4(b) are schematics of a process of forming a gas passage;

FIGS. 5(a) and 5(b) are schematics of the process of forming the gas passage;

FIG. 6 is a schematic end view of a substrate of the fuel cell in a manufacturing process according to the exemplary embodiment;

FIG. 7 is a schematic end view of the substrate of the fuel cell in the manufacturing process according to the exemplary embodiment;

FIG. 8 is a schematic end view of the substrate of the fuel cell in the manufacturing process according to the exemplary embodiment;

FIG. 9 is a schematic of a process of forming a reaction layer;

FIG. 10 is a schematic of a process of forming the reaction layer;

FIG. 11 is a schematic of a process of forming the reaction layer;

FIG. 12 is a schematic of a process of forming the reaction layer;

FIG. 13 is a schematic of the substrate of the fuel cell in the manufacturing process according to the exemplary embodiment;

FIG. 14 is a schematic of the substrate of the fuel cell in the manufacturing process according to the exemplary embodiment;

FIG. 15 is a schematic of the substrate of the fuel cell in the manufacturing process according to the exemplary embodiment;

FIG. 16 is a schematic of the substrate of the fuel cell in the manufacturing process according to the exemplary embodiment;

FIG. 17 is a schematic of the substrate of the fuel cell in the manufacturing process according to the exemplary embodiment;

FIG. 18 is a schematic of the substrate of the fuel cell according to the exemplary embodiment; and

FIG. 19 is a schematic that shows a large fuel cell composed of a plurality of fuel cells according to this exemplary embodiment.

### DETAILED DESCRIPTION OF EMBODIMENTS

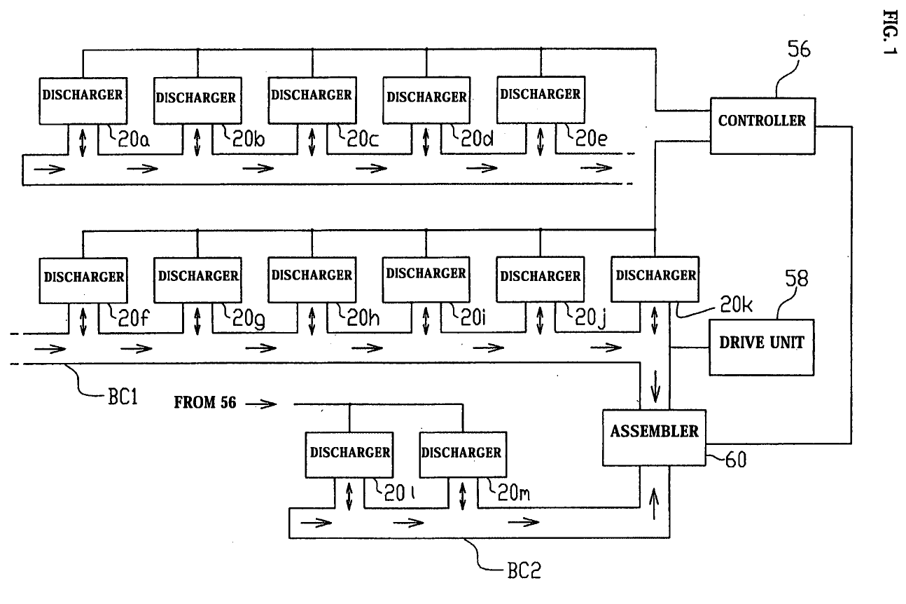

An exemplary embodiment of a method of manufacturing a fuel cell according to the present invention is described in detail below with reference to the accompanying drawings. FIG. 1 shows a configuration example of a fuel cell manufacturing line in which the manufacturing process of a fuel cell according to the exemplary embodiments is carried out. As shown in FIG. 1, this fuel cell manufacturing line includes dischargers 20a through 20m, a belt conveyor BC1 that couples up the dischargers 20a through 20k, a belt conveyor BC2 that couples up the discharger 201 and 20m, a drive unit 58 that drives the belt conveyors BC1 and BC2, an assembler 60 assembling a fuel cell, and a controller 56 controlling the overall fuel cell manufacturing line.

The dischargers 20a through 20k are aligned along the belt conveyor BC 1 at regular intervals. The dischargers 201 and 20m are aligned along the belt conveyor BC2 at a regular interval. The controller 56 is coupled to the dischargers 20a through 20k, the drive unit 56 and the assembler 60. The belt conveyor BC1 is driven according to a control signal from the drive unit 56 and conveys a fuel cell substrate (hereinafter “substrate”) to the dischargers 20a through 20k. The substrate is treated by the dischargers 20a through 20k. In the same way, the belt conveyor BC2 is driven according to a control signal from the drive unit 56 and conveys a substrate to the dischargers 201 and 20m. Then, the substrate is treated by the dischargers 201 and 20m. The belt conveyors BC1 and BC2 then convey the substrate to the assembler 60. The assembler 60 assembles the substrates into a fuel cell according to a control signal from the controller 56.

In the fuel cell manufacturing line, a resist solution is applied to the substrate at the discharger 20a in order to form a gas passage, and then etching is performed at the discharger 20b in order to form the gas passage. At the discharger 20c, support carbon that supports a current-collecting layer is applied to the substrate.

A process of forming the current-collecting layer is performed at the discharger 20d, a process of forming a gas-diffusion layer is performed at the discharger 20e and a process of forming an electrolyte membrane is performed at the discharger 20g. Moreover, a process of forming a reaction layer is performed at the discharger 20h, a process of forming a gas-diffusion layer is performed at the discharger 20i, a process of forming a current-collecting layer is performed at the discharger 20j and a process of applying the support carbon is performed at the discharger 20k.

At the discharger 201, a resist solution is applied to the substrate in order to form a gas passage and etching is performed at the discharger 20m in order to form the gas passage. In a case where a first substrate is treated by the dischargers 20a through 20k, a second substrate is treated by the dischargers 201 and 20m in order to form the gas passage.

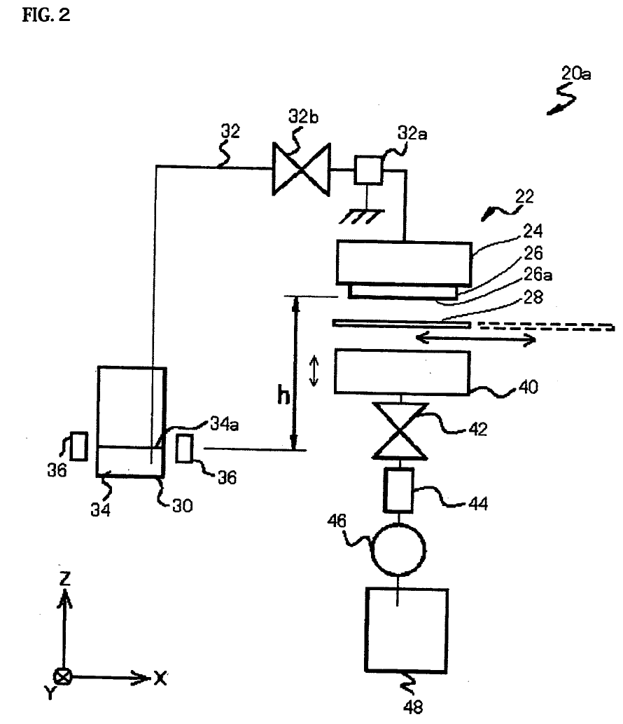

FIG. 2 shows a schematic structure of the ink-jet discharger 20a that is used in the manufacturing process of a fuel cell according to the exemplary embodiment of the present invention. The ink-jet discharger 20a has an inkjet head 22 to discharge things to the substrate. The ink-jet head 22 includes a head body 24 and a nozzle formed face 26 to which a plurality of nozzles that discharge things are formed. From the nozzles formed on the nozzle formed face 26, the resist solution is discharged so as to be applied to the substrate when the gas passage is formed in the substrate. A reactive gas is supplied through the gas passage.

The discharger 20a also has a table 28 on which the substrate is placed. The table 28 is movable in predetermined directions, for example, in X-axis direction and Y-axis direction. The table 28 moves in the X-axis direction indicated by an arrow shown in FIG. 2 to hold the substrate conveyed by the belt conveyor BC1 and to introduce the substrate into the discharger 20a.

A tank 30 is coupled to the ink-jet head 22. The tank 30 contains the resist solution that will be discharged from the nozzles formed on the nozzle formed face 26. The tank 30 and the ink-jet head 22 are coupled together with a carrier pipe 32 through which things to be discharged are conveyed. The carrier pipe 32 has an earth joint 32a and a bubble removal valve 32b. The earth joint 32a is placed in a flow path of a discharging material and reduces or prevents an electrical charge in the passage of the carrier pipe 32. The bubble removal valve 32b is placed in the head and used when the discharging material in the ink-jet head 22 is suctioned by a suction cap 40 that is described below. More particularly, when the discharging material in the ink-jet head 22 is suctioned by the suction cap 40, the bubble removal valve 32b is closed and it stops things from coming into the ink-jet head 22 from the tank 30. And then, when the suction cap 40 suctions the discharging material to be discharged, a flow speed of the discharging material gets faster and bubbles in the ink-jet head 22 will be swiftly ejected.

The tank 30 has a liquid level control sensor 36 that controls a capacity of a thing contained in the tank 30, in other words, a liquid level 34a of the resist solution contained in the tank 30. This liquid level control sensor 36 maintains a height difference h (hereinafter “water-head value”) between an end 26a of the nozzle formed surface 26 in the ink-jet head 22 and the liquid level 34a in the tank 30 within a predetermined range. A discharging material 34 contained in the tank 30 can be sent to the ink-jet head 22 in a pressure within a predetermined range by controlling the liquid level 34a. By sending the discharging material 34 in the pressure within the predetermined range, the discharging material 34 can be stably discharged from the ink-jet head 22.

The suction cap 40 is placed so as to oppose the nozzle formed surface 26 of the ink-jet head 22 with a certain space therebetween. The suction cap 40 suctions the discharging material in the nozzles of the ink-jet head 22. The suction cap 40 is movable in Z-axis direction indicated by another arrow shown in FIG. 2. This suction cap 40 is firmly attached to the nozzle formed surface 26 so as to surround the plurality of the nozzles formed on the nozzle formed surface 26. In this way, the nozzles are sealed off in a space between the suction cap 40 and the nozzle formed surface 26 and kept away from outside air. The suction of the discharging material in the ink-jet head 22 by the suction cap 40 is performed when the ink-jet head 22 is not discharging the discharging material 34. For example, when the ink-jet head 22 is in an off-position and the table 28 is in the position indicated by the dashed line in FIG. 2, the suction may be performed.

A passage is provided below the suction cap 40. In the passage, there are a suction valve 42, a suction pressure sensor 44 that can detect abnormal suction and a suction pump 46 which is, for example, a tube pump. The discharging material 34 suctioned by the suction pump 46 and the like is conveyed through the passage then stored in a waste storage tank 48.

The structure of each of the dischargers 20b through 20m is same as that of the discharger 20a. Therefore, those explanations are omitted, and components and parts of the dischargers 20b through 20m are also respectively given the same identical numerals as those of the dischargers 20a. The tank 30 provided in each discharger 20b through 20m contains a necessary material to perform a respective treatment at each discharger. For example, the tanks 30 of the dischargers 20b and 20m contain a discharging material that is used for the etching to form the gas passage. The tanks 30 of the dischargers 20c and 20k contain a discharging material that is used to form the support carbon. The tanks 30 of the dischargers 20d and 20j contain a discharging material that is used to form the current-collecting layer. The tanks 30 of the dischargers 20e and 20i contain a discharging material that is used to form the gas-diffusion layer. The tanks 30 of the dischargers 20f and 20h contain a discharging material that is used to form the reaction layer. The tank 30 of the discharger 20g contains a discharging material that is used to form the electrolyte membrane. The tank 30 of the discharger 201 contains the same discharging material as the one contained in the tank of the discharger 20a in order to form the gas passage.

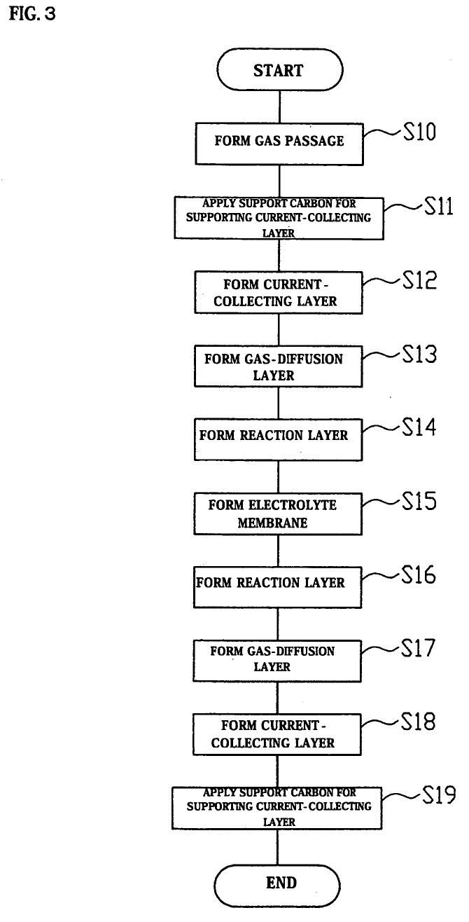

Next, the method of manufacturing a fuel cell by using the dischargers 20a through 20m according to the exemplary embodiment is described below with reference to a flow chart shown in FIG. 3 and the other accompanying drawings.

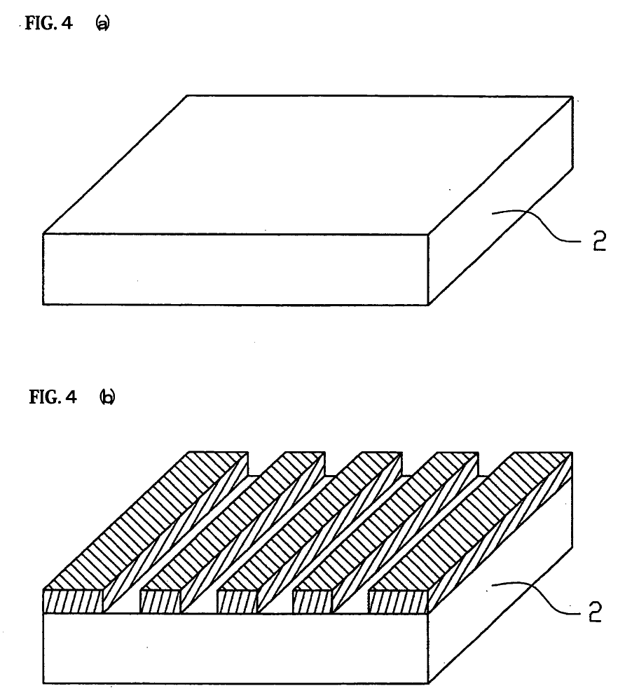

First of all, the gas passage through which the reactive gas is supplied is formed on the substrate (Step 10). A substrate 2 (first substrate), which has a rectangular and flat shape, as shown in FIG. 4(a) and is made of, for example, silicon, is conveyed to the discharger 20a by the belt conveyor BC1. The substrate 2 is then put on the table 28 of the discharger 20a and introduced into the discharger 20a. The discharger 20a discharges the resist solution contained in the tank 30 through the nozzle of the nozzle formed surface 26 and applies the solution to a predetermined area of the top surface of the substrate 2 placed on the table 28. Here, the resist solution is linearly applied with a predetermined interval between the lines in a direction which is from the front side to the back side in FIG. 4(b). In other words, the resist solution will not be applied on an area, for example, where the gas passage (a first gas passage) through which a first reactive gas containing hydrogen is supplied is formed. The resist solution is applied an area except the above-described area.

Then, the substrate 2 to which the resist solution was applied in the predetermined position (see FIG. 4(b)) is conveyed to the discharger 20b by the belt conveyor BC1. The substrate 2 is then put on the table 28 of the discharger 20b and introduced into the discharger 20b. The discharger 20b discharges an etching solvent contained in the tank 30 through the nozzle of the nozzle formed surface 26 and applies the solution to the whole top surface of the substrate 2 placed on the table 28. The etching solvent is, for example, a solution of hydrofluoric acid and used for the etching to form the gas passage.

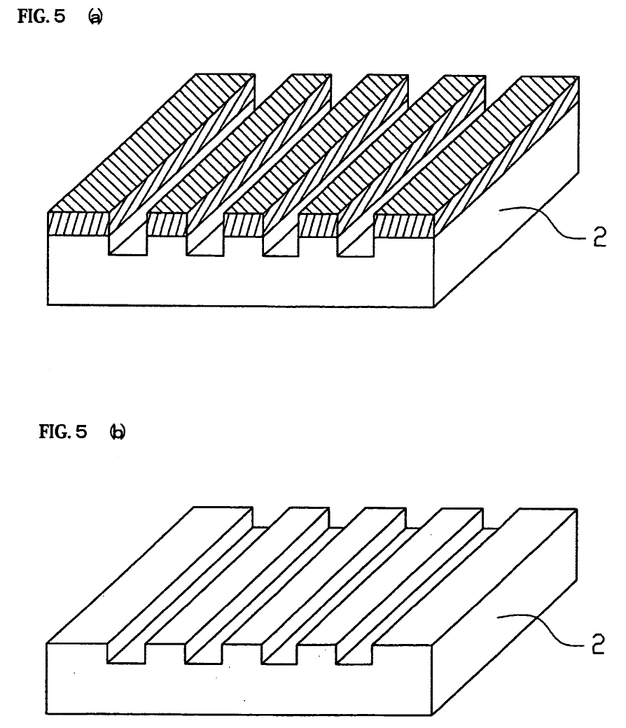

Here, the area where the resist solution is not applied is etched by the solution of hydrofluoric acid and the gas passage is formed on the substrate 2, as shown in FIG. 5(a). To be more specific, the gas passage that is U-shaped in sectional view and extends from one side face to the other side face of the substrate 2 is formed. The substrate 2 in which the gas passage was formed as shown in FIG. 5(a) is washed to remove the resist in cleaning equipment (not shown). Then, the substrate 2 in which the gas passage was formed as shown in FIG. 5(b), is moved to the belt conveyor BC1 from the table 28 and conveyed to the discharger 20c by the belt conveyor BC 1.

Next, the support carbon (a first supporting member) that supports the current-collecting layer is applied to the inside of the gas passage (Step 11) in order to discourage or prevent the gas passage which has been formed in the substrate 2 in Step 10 from being blocked off by the current-collecting layer. Firstly, the substrate 2, which was conveyed to the discharger 20c by the belt conveyor BC1, is put on the table 28 of the discharger 20c and introduced into the discharger 20c. The discharger 20c then discharges a support carbon 4 contained in the tank 30 through the nozzle of the nozzle formed surface 26 and applies it to the inside of the gas passage formed in the substrate 2. Here, a porous carbon with a predetermined particle diameter, for example, from 1-5 μm is used as the support carbon 4. The size of the porous carbon particle is selected, such that the reactive gas can securely flow in the gas passage, and such that it can discourage or prevent the gas passage from being blocked off by the current-collecting layer.

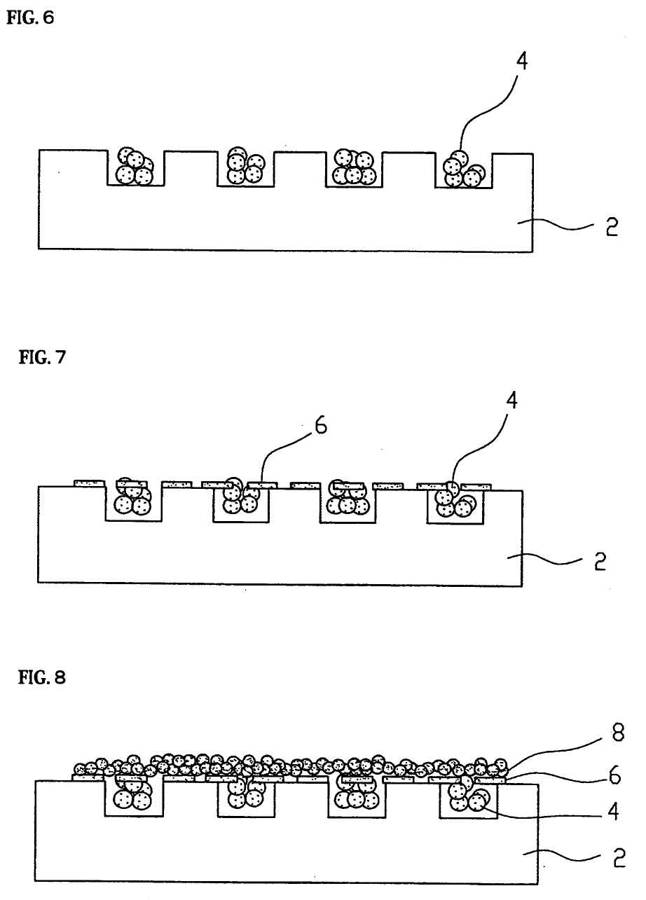

FIG. 6 is an end view of the substrate 2 to which the support carbon 4 was applied. As shown in FIG. 6, it can discourage or prevent the current-collecting layer formed on the substrate 2 from falling into the gas passage by applying the support carbon 4 to the inside of the gas passage. The substrate 2 to which the support carbon 4 has been applied is moved to the belt conveyor BC1 and conveyed to the discharger 20d by the belt conveyor BC1.

Next, the current-collecting layer (a first current-collecting layer) that collects electrons produced by a reaction of the reactive gas is formed (Step 12). Firstly, the substrate 2, which was conveyed to the discharger 20d by the belt conveyor BC 1, is placed on the table 28 of the discharger 20d and introduced into the discharger 20d. The discharger 20d then discharges a material that is contained in the tank 30 and to form a current-collecting layer 6 through the nozzle of the nozzle formed surface 26 and applies it to the substrate 2 on the table 28. The material is, for example, a conductive material, such as copper. The conductive material is discharged in a form that does not or substantially not prevent diffusion of the reactive gas supplied to the gas passage, for example, in a net-like form. In this way, the current-collecting layer 6 is formed.

FIG. 7 is an end view of the substrate 2 to which the current-collecting layer 6 was formed. As shown in FIG. 7, the current-collecting layer 6 is supported by the support carbon 4 in the gas passage formed on the substrate 2, and this discourages or prevents the current-collecting layer 6 from falling into the gas passage. The substrate 2 to which the current-collecting layer 6 has been formed is moved to the belt conveyor BC1 from the table 28 and conveyed to the discharger 20e by the belt conveyor BC1.

Next, the gas-diffusion layer in which the reactive gas supplied through the gas passage in the substrate 2 is diffused is formed on the current-collecting layer 6 that has been formed in Step 12 (Step 13). Firstly, the substrate 2, which was conveyed to the discharger 20e by the belt conveyor BC1, is put on the table 28 of the discharger 20e and introduced into the discharger 20e. The discharger 20e then discharges a material that is contained in the tank 30 and for forming a gas-diffusion layer 8 through the nozzle of the nozzle formed surface 26 and applies it on the current-collecting layer 6. The material for the gas-diffusion layer 8 is, for example, carbon. In this way, the gas-diffusion layer 8 in which the reactive gas (the first reactive gas) supplied through the gas passage is diffused is formed.

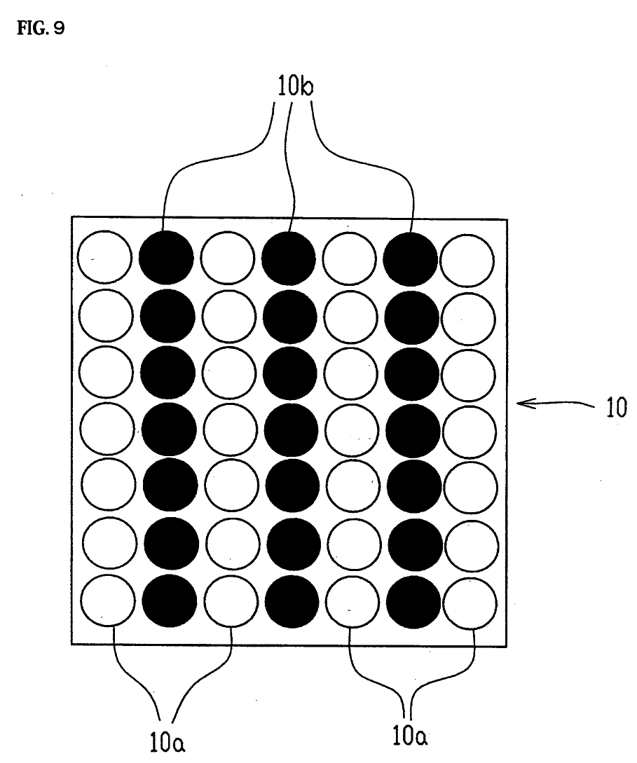

FIG. 8 is an end view of the substrate 2 on which the gas-diffusion layer 8 was formed. As shown in FIG. 8, for example, carbon that can serve as an electrode is discharged on the current-collecting layer 6 and the gas-diffusion layer 8 in which the reactive gas is diffused has been formed. Here, as the carbon that forms the gas-diffusion layer 8, a porous carbon with a size with which the reactive gas supplied through the gas passage can be sufficiently diffused is used. For example, the porous carbon with a particle size about 0.1-1 μm diameter which is smaller than the size of the support carbon 4 is used. The substrate 2 on which the gas-diffusion layer 8 has been formed is moved to the belt conveyor BC1 from the table 28 and conveyed to the discharger 20f by the belt conveyor BC1.

Next, the reaction layer (a first reaction layer) that reacts according to the reactive gas supplied through the gas passage is formed on the gas-diffusion layer 8 that was formed in Step 13 (Step 14). Firstly, the substrate 2, which was conveyed to the discharger 20f by the belt conveyor BC1, is placed on the table 28 of the discharger 20f and introduced into the discharger 20f. The discharger 20f then discharges a material that is contained in the tank 30 and forms the reaction layer through the nozzle, and applies it in several times to respectively different positions of the gas-diffusion layer 8. Here, as the material that forms the reaction layer, for example, a catalytic solution that contains platinum particles with a diameter of from a few to several tens nanometers dispersed in a certain solvent is used. In this way, a reaction layer 10 is formed.

Here, the reaction layer 10 is formed by applying the catalytic solution in which platinum particles are dispersed in several times on the gas-diffusion layer 8 according to a pattern which is preset in the discharger 20f. More particularly, the table 28 of the discharger 20f is moved in the X-axis and Y-axis direction shown in FIG. 2 and the catalytic solution is applied to different positions of the gas-diffusion layer 8 to form the reaction layer 10.

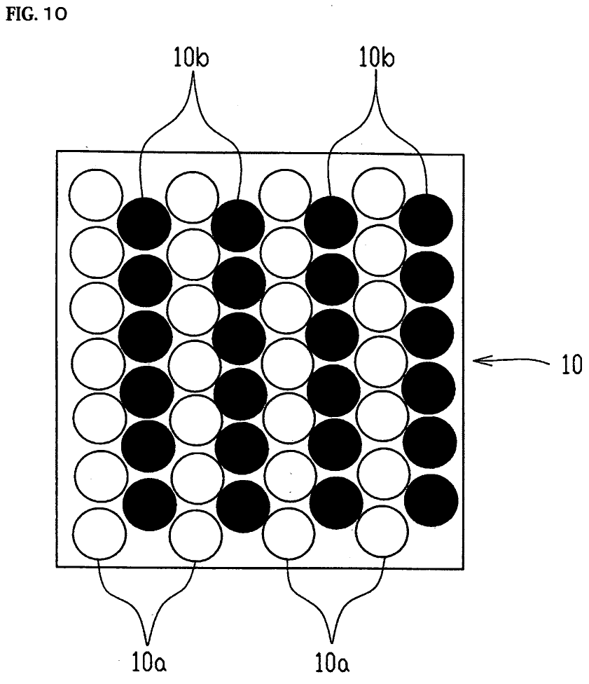

FIG. 9 shows an example of a discharging pattern to form the reaction layer 10. In FIG. 9 shows a case where the catalytic solution is applied several times and a droplet that is firstly applied is indicated by a droplet 10a. A droplet that is applied after the first time application is indicated by a droplet 10b. The catalytic is firstly applied to a position indicated by the droplet 10a and then the catalytic is secondly applied to a place where the catalytic is not applied yet, in other words, a position indicated by the droplet 10b. This is the pattern to form the reaction layer 10 shown in FIG. 9. Therefore, the table 28 of the discharger 20f is sequentially moved in the X-axis and Y-axis direction shown in FIG. 2 according to the pattern shown in FIG. 9 and the discharger 20f applies the catalytic solution to the position indicated by the droplet 10a. Then, the discharger 20f applies the catalytic solution to the position indicated by the droplet 10b. In this way, the reaction layer 10 to which the catalytic solution is evenly applied can be formed.

FIG. 10 shows other example of the discharging pattern to form the reaction layer 10. In FIG. 10, a droplet that is firstly applied is indicated by the droplet 10a and a droplet that is secondly applied is indicated by the droplet 10b in the same way as FIG. 9. In the pattern shown in FIG. 10, when the catalytic solution is firstly applied to the position indicated by the droplet 10a, the catalytic solution is secondly applied to a place where the catalytic is not applied and between adjacent two droplets 10a, in other words, a position indicated by the droplet 10b in FIG. 10. Therefore, the catalytic solution is firstly applied to the position indicated by the droplet 10a and secondly applied to the position indicated by the droplet 10b. In this way, the reaction layer 10 to which the catalytic solution is evenly applied can be formed.

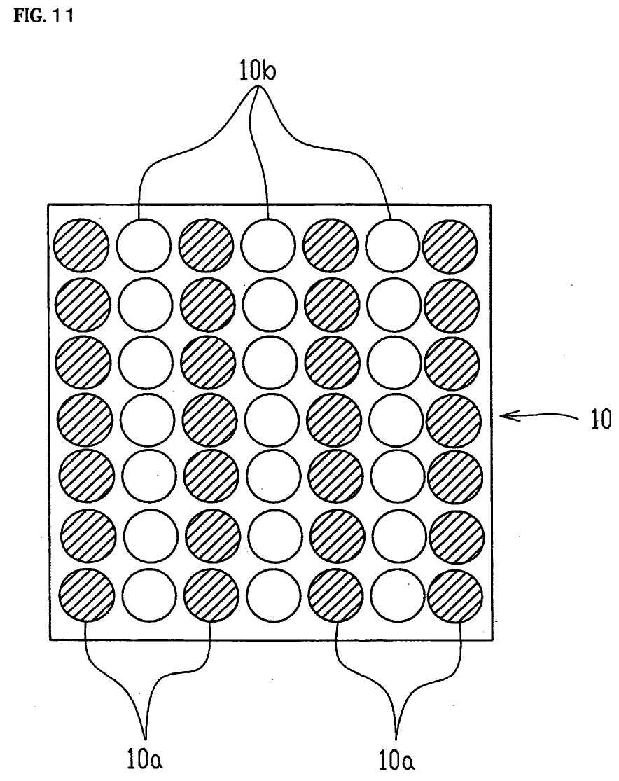

FIG. 11 shows other example of the discharging pattern to form the reaction layer 10. In FIG. 11, a droplet of the catalytic solution that is firstly applied and then dried by an intermediate drying is indicated by the droplet 10a. A droplet of the catalytic solution that is secondly applied after the intermediate drying is indicated by the droplet 10b. In the pattern shown in FIG. 11, in a case where the catalytic solution is firstly applied to the position indicated by the droplet 10a, the substrate 2 on which the droplet 10a has been applied is dried by, for example, heating the substrate to a predetermined temperature. Following the drying, the catalytic solution is applied to the position indicated by the droplet 10b and the pattern shown in FIG. 11 is formed. Therefore, the catalytic solution is firstly applied to the position indicated by the droplet 10a and secondly applied to the position indicated by the droplet 10b after the intermediate drying is performed. In this way, the reaction layer 10 to which the catalytic solution is evenly applied can be formed. Even when a catalytic solution that includes a solvent with a high surface tension and a low permeability, for example, a water or glycerin-based solvent, a dispersant added in the solvent and the platinum particles dispersed in the solvent is applied, the reaction layer 10 in which the platinum particles are evenly dispersed can be formed with the pattern shown in FIG. 11. Because the intermediate drying can discourage or prevent a droplet that has been already applied from binding to a droplet that is freshly applied and the crystal of the platinum particles from growing large, the reaction layer in which the small crystal of the platinum particles is evenly dispersed can be formed.

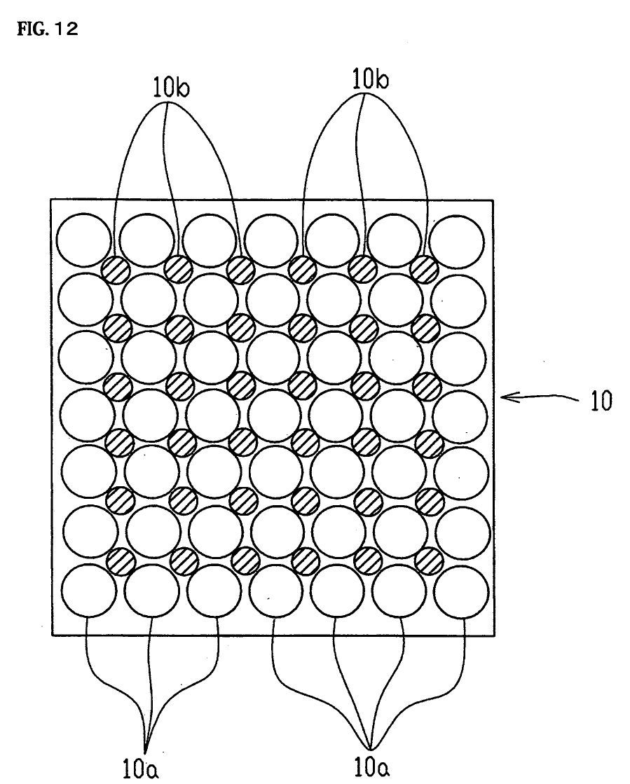

FIG. 12 shows other example of the discharging pattern to form the reaction layer 10. In FIG. 12, a droplet of the catalytic solution that is firstly applied is indicated by the droplet 10a and a droplet of the catalytic solution that is secondly applied is indicated by the droplet 10b. In the pattern shown in FIG. 12, the catalytic solution is firstly applied to the position indicated by the droplet 10a and the catalytic solution in a form of a droplet with a different size from the size of the droplet 10a is secondly applied to a position indicated by the droplet 10b in FIG. 12.

In this case, a wave form that drives the discharger 20f to firstly apply the catalytic solution and a wave form that drives the discharger 20f to secondly apply the catalytic solution is different. In other words, a size of the droplet discharged through the nozzle of the discharger 20f can be changed by changing the wave form that drives the discharger 20f. This is how to make the size of the droplet 10a and that of the droplet 10b different in this embodiment. Accordingly, after the catalytic solution is applied to the position indicated by the droplet 10a, the catalytic solution indicated by the droplet 10b is applied to a blank space among droplets 10a shown in FIG. 12. In this way, an area of the blank space where the catalytic solution is not applied will be decreased and the reaction layer 10 to which the catalytic solution is evenly applied can be obtained.

In FIGS. 9 through 12, the catalytic solution is applied such that the droplet 10a and the droplet 10b do not overlap each other. However, the catalytic solution may be applied such that a part of the droplet 10a and the droplet 10b overlap. This means that the catalytic solution may be applied such that a peripheral part of the droplet 10b partially overlaps a peripheral part of the droplet 10b in order to equalize a concentration distribution of the catalytic in the reaction layer 10. It can discourage or prevent the blank space where the catalytic solution is not applied from being left on the gas-diffusion layer 8. Also, this makes it possible to maintain the concentration distribution of the catalytic in the reaction layer 10 uniform.

Here, the discharging pattern that is decided in consideration of a material used for manufacturing the fuel cell, application of the manufactured fuel cell, a use environment of the fuel cell and the like is set in the discharger 20f in advance. More particularly, any of the above-described patterns shown in FIGS. 9 through 12 or a pattern combined any two of the above-described patterns shown in FIGS. 9 through 12 is preset. For example, when a catalytic solution with a high permeability, such as an isopropyl alcohol-based solution, is used to form the reaction layer 10, any one of the patterns shown in FIGS. 9, 10 and 12 is set in the discharger. When a catalytic solution with the high surface tension and the low permeability, such as a water or glycerin-based solution, is used to form the reaction layer 10, any one of the patterns shown in FIG. 11 is set in the discharger.

Here, the catalytic solution is made by adding the dispersant in the solvent and dispersing the platinum particles in the solvent. After the catalytic solution is applied on the gas-diffusion layer 8, the dispersant is removed by, for example, heating the substrate 2 to 200° C. in a nitrogen atmosphere. In this case, the platinum particles dispersed in the solvent as catalyst are attached to the surface of the carbon that forms the gas-diffusion layer 8 and then the reaction layer 10 is formed. In a case where the intermediate drying is carried out after the first application of the catalytic solution, and then the second time application is further carried out, this dispersant removal process is also performed after the application of the catalytic solution.

FIG. 13 is an end view of the substrate 2 on which the reaction layer 10 is formed. As shown in FIG. 13, the reaction layer 10 is formed by applying the catalytic solution in which the platinum particles dispersed as catalyst to the gas-diffusion layer 8. The substrate 2 on which the reaction layer 10 has been formed is moved to the belt conveyor BC1 from the table 28 and conveyed to the discharger 20g by the belt conveyor BC1.

Next, the electrolyte membrane, such as an ion-exchange membrane, is formed on the reaction layer 10 that was formed in Step 14 (Step 15). Firstly, the substrate 2, which was conveyed to the discharger 20g by the belt conveyor BC1, is placed on the table 28 of the discharger 20g and introduced into the discharger 20g. The discharger 20g then discharges a material that is contained in the tank 30 and forms the electrolyte membrane through the nozzle of the nozzle formed surface 26 and applies it to the reaction layer 10. Here, as the material that forms the electrolyte membrane, for example, a ceramic solid electrolyte such as “Nafion” (registered trademark), tungstophosphoric acid and molybdophosphoric acid is used. Such a ceramic solid electrolyte is adjusted to have a predetermined viscosity and then discharged on the reaction layer 10 through the nozzle of the nozzle formed surface 2 to form an electrolyte membrane 12.

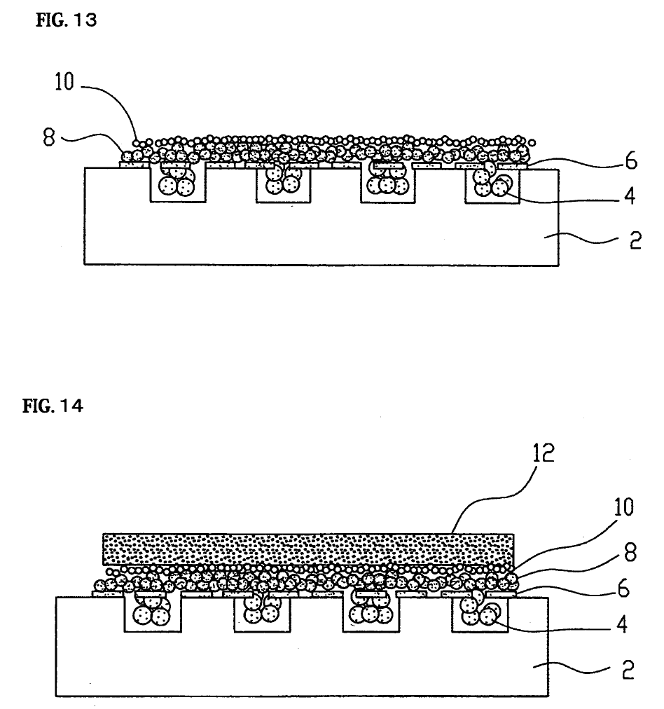

FIG. 14 is an end view of the substrate 2 on which the electrolyte membrane 12 is formed. As shown in FIG. 14, the electrolyte membrane 12 having a predetermined thickness is formed on the reaction layer 10. The substrate 2 on which the electrolyte membrane 12 has been formed is moved to the belt conveyor BC1 from the table 28 and conveyed to the discharger 20h by the belt conveyor BC1.

Next, the other reaction layer (a second reaction layer) is formed on the electrolyte membrane 12 that was formed in Step 15 (Step 16). Firstly, the substrate 2, which was conveyed to the discharger 20h by the belt conveyor BC1, is put on the table 28 of the discharger 20h and introduced into the discharger 20h. The discharger 20h discharges a solution in which the platinum supported carbon as the catalyst is dispersed in the same way as the discharger 20f did and a reaction layer 10′ is formed.

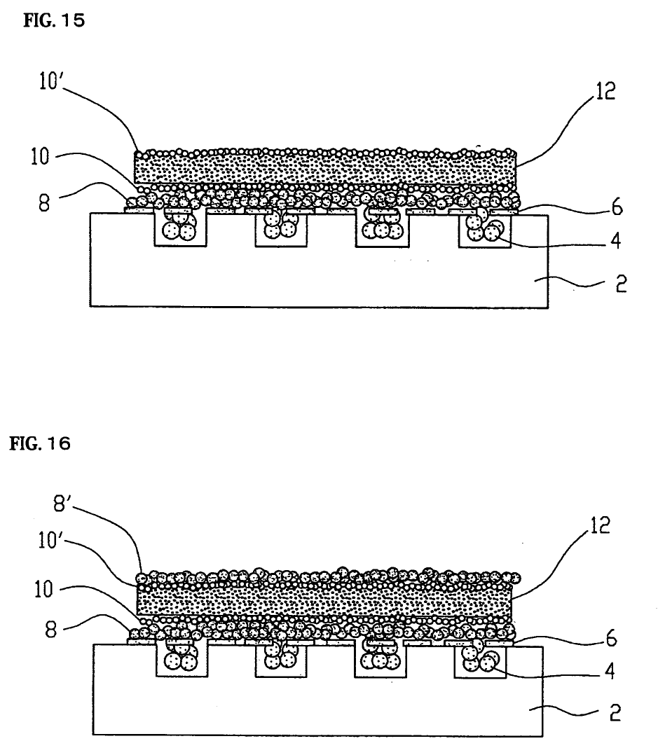

FIG. 15 is an end view of the substrate 2 on which the reaction layer 10′ is formed on the electrolyte membrane 12. As shown in FIG. 15, the reaction layer 10′ is formed by applying the platinum supported carbon which is the catalyst to the electrolyte membrane 12. Here, the reaction layer 10′ is a layer that reacts according to a second reactive gas, for example, a reactive gas containing oxygen.

Next, the other gas-diffusion layer in which the reactive gas (the second reactive gas) is diffused is formed on the reaction layer 10′ that was formed in Step 16 (Step 17). Firstly, the substrate 2 on which the reaction layer 10′ is formed is conveyed to the discharger 20i by the belt conveyor BC1. The discharger 20i discharges the porous carbon with a predetermined particle size in the same way as the discharger 20e, and a gas-diffusion layer 8′ is formed.

FIG. 16 is an end view of the substrate 2 on which the gas-diffusion layer is formed on the reaction layer 10′. As shown in FIG. 16, the gas-diffusion layer 8′ is formed by applying the porous carbon to the reaction layer 10′.

Next, the other current-collecting layer (a second current-collecting layer) is formed on the gas-diffusion layer 8′ that was formed in Step 17 (Step 18). The support carbon (a second supporting member) that supports this current-collecting layer is then applied to the current-collecting layer (Step 19). Firstly, the substrate 2, which was conveyed to the discharger 20j by the belt conveyor BC1, is placed on the table 28 of the discharger 20j and introduced into the discharger 20j. A current-collecting layer 6′ is formed on the gas-diffusion layer 8′ in the discharger 20j by the same process carried out in the discharger 20d. Secondly, the substrate 2, which was conveyed to the discharger 20k by the belt conveyor BC1, is placed on the table 28 of the discharger 20k and then introduced into the discharger 20k. A support carbon 4′ is applied by the discharger 20k in the same way as the discharger 20c. The substrate 2 on which the support carbon 4′ has been applied is moved to the belt conveyor BC1 from the table 28 and conveyed to the assembler 60.

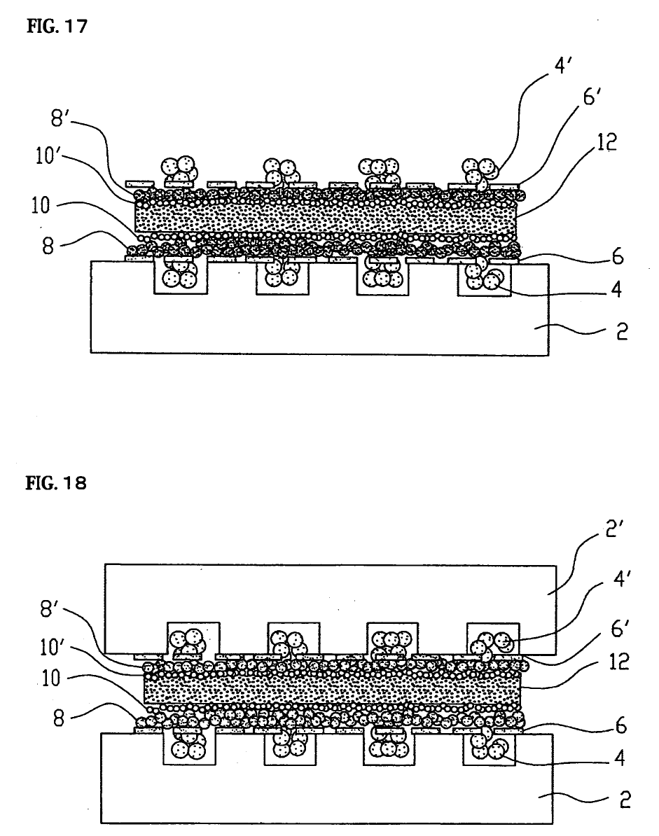

FIG. 17 is an end view of the substrate 2 on which the current-collecting layer 6′ and the support carbon 4′ are applied on the gas-diffusion layer 8′. As shown in FIG. 17, the current-collecting layer 6′ is formed in the above-described step 18 and the support carbon 4′ is applied in the above-described step 19. Here, the support carbon 4′ is applied according to the gas passage formed in the substrate in the same manner way as the support carbon 4 was applied.

Next, the fuel cell is assembled by placing the substrate (the second substrate) in which the gas passage was formed on the substrate (the first substrate) to which the support carbon was applied in Step 19 (Step 20). To be more specific, a substrate 2′ (the second substrate) conveyed by the belt conveyor BC2 is placed on the substrate 2 (the first substrate) conveyed by the belt conveyor BC 1 to assemble the fuel cell. Here, a second gas passage has been formed in the substrate 2′ by processes other than the process of Steps 10 through 19. The second gas passage is formed in the dischargers 201 and 20m by the same process as the one performed in the dischargers 20a and 20b. The substrate 2′ is placed on the substrate 2 in a way that the gas passage, which is U-shaped in sectional view and extends from one side face to the other side face of the substrate 2, aligns parallel to the gas passage that is U-shaped in sectional view and formed in the substrate 2′. In this way, the fuel cell is assembled and the manufacturing process of the fuel cell is completed.

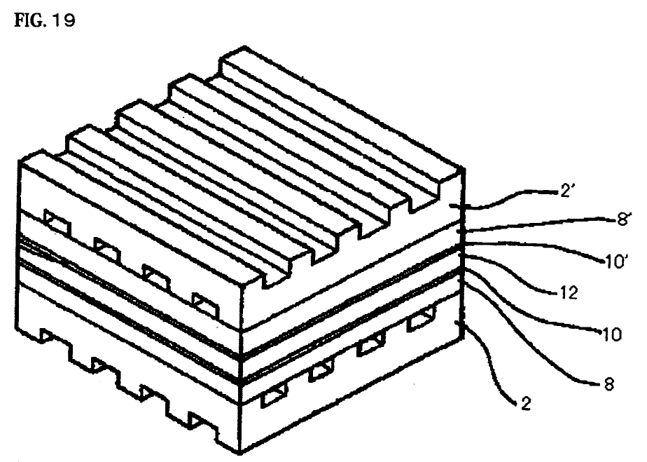

FIG. 18 is an end view of the manufactured fuel cell. As shown in FIG. 18, the substrate 2′ in which the second gas passage is formed is placed on a predetermined position of the substrate 2. In this way, the fuel cell, in which the fist reactive gas is supplied through the first gas passage formed in the first substrate and the second reactive gas is supplied through the second gas passage formed in the second substrate, is produced.

The fuel cell manufactured by the above-described method can be installed as a power supply in electronic equipment, particularly, a portable electronic device, such as a cellular phone. A small sized fuel cell can be easily manufactured by using the dischargers according to the above-described manufacturing method. Thereby, it can be equipped as the power supply in small electronic equipment, such as a cellular phone, for example.

In the method of manufacturing a fuel cell according to this exemplary embodiment, the reaction layer is formed by using the ink-jet discharger. Therefore, the catalytic solution can be evenly applied to a desired position and the reaction layer in which the catalyst is uniformly dispersed can be formed. This leads to the high reaction efficiency and a fuel cell with the high reaction efficiency can be easily manufactured.

Furthermore, in the method of manufacturing a fuel cell according to this exemplary embodiment, a position where the catalytic solution is firstly applied is different from a position where the catalytic solution is secondly applied. Therefore, the catalytic solution can be evenly applied on the substrate. This leads to formation of the reaction layer in which the platinum particles are evenly dispersed and the fuel cell with the high reaction efficiency can be easily manufactured.

Moreover, in the method of manufacturing a fuel cell according to this exemplary embodiment, the catalytic solution is secondly applied to a place where the catalytic is not applied yet and between adjacent two droplets that has been already applied. Therefore, the blank space where the catalytic solution is not applied will not be left, and it can discourage or prevent the situation where a relatively large amount of catalytic solution is partially applied and the crystal of the platinum particles grows large. Accordingly, all the platinum particles will be kept small, and the platinum particles can be uniformly dispersed. Thereby, an area of the catalyst or the platinum particles in the whole reaction layer is increased and the fuel cell with the high reaction efficiency can be manufactured.

Furthermore, in the method of manufacturing a fuel cell according to this exemplary embodiment, the second application is performed after the intermediate draying of the catalytic solution that is firstly applied in order to form the reaction layer. Thereby, for example, even when a catalytic solution with the high surface tension is applied, the intermediate drying can discourage or prevent a droplet that has been already applied from binding to a droplet that is freshly applied and becomes one droplet. This discourages or prevents the crystal of the platinum particles from growing large, and the reaction layer in which the platinum particles are evenly dispersed can be formed. This leads to the fuel cell with the high reaction efficiency.

Moreover, in the method of manufacturing a fuel cell according to this exemplary embodiment, after a droplet of the catalytic solution is firstly applied to the substrate, a droplet that is smaller than that of the first application is applied to the blank space among the first droplets to form the reaction layer. In this way, the catalytic solution can be evenly applied without leaving any blank space on the substrate and the fuel cell with the high reaction efficiency can be manufactured.

In the method of manufacturing a fuel cell according to the above-described exemplary embodiment, the ink-jet dischargers are used in the all steps. However, the fuel cell may be manufactured by using the ink-jet discharger only in a step of forming the reactive layer.

Though the small size fuel cell is manufactured in the method of manufacturing a fuel cell according to the above-described exemplary embodiment, a large size fuel cell may be manufactured by building up several fuel cells. For example, another gas passage may be formed on a back side of the substrate 2′ shown in FIG. 19 and then another gas-diffusion layer, reaction layer, electrolyte membrane and the like may be formed on the back side of the substrate 2′ by the same process as the above-described manufacturing method. In this way, several fuel cells can be built up and the large size fuel cell is manufactured. Such a large fuel cell can be used as a power supply for electric vehicles and an environment-friendly vehicle operating via clean energy can be provided.

Furthermore, such a large fuel cell can also be used for a co-generation system, which can provide heat and other energy, such as electricity taken out from one energy source. The fuel cell produces a large amount of heat energy when it generates electric power. Therefore, a high efficiency co-generation system for household use or commercial use can be realized with the fuel cell. Moreover, there is no emission of toxic or harmful substance when the fuel cell generates electric power. Thereby, an environment-friendly co-generation system can be realized.

In the method of manufacturing a fuel cell according to exemplary embodiments of the present invention, at least one of the first reaction layer and the second reaction layer is formed by applying the catalytic solution containing a catalyst material several times to different places of the substrate at each time. Therefore, the catalytic solution is evenly applied to the substrate and the fuel cell with the high reaction efficiency can be easily manufactured. Furthermore, the catalyst, such as the platinum particle, is uniformly dispersed in the reaction layer because the catalytic solution is applied in several times to respectively different places of the substrate. Therefore, the fuel cell with the high reaction efficiency can be easily manufactured.

1. A method of manufacturing a fuel cell, comprising:
forming a first gas passage through which a first reactive gas is supplied on a first substrate;
forming a first current-collecting layer that collects electrons produced by a reaction of the first reactive gas supplied through the first gas passage;
forming a first reaction layer that reacts according to the first reactive gas supplied through the first gas passage;
forming a second gas passage through which a second reactive gas is supplied on a second substrate;
forming a second current-collecting layer that provides necessary electrons to react the second reactive gas supplied through the second gas passage;
forming a second reaction layer that reacts according to the second reactive gas supplied through the second gas passage; and
forming at least one of the first reaction layer and the second reaction layer by using a discharger to apply a catalytic solution containing a catalyst material several times to respectively different places of the substrate.

2. The method of manufacturing a fuel cell according to claim 1, further comprising:
firstly applying the catalytic solution to the substrate; and
secondly applying the catalytic solution to a position other than an area where the catalytic solution was firstly applied in order to form at least one of the first reaction layer and the second reaction layer.

3. The method of manufacturing a fuel cell according to claim 1, further comprising:
firstly applying the catalytic solution to the substrate;
drying the applied catalytic solution after the catalytic solution was firstly applied; and
secondly applying the catalytic solution to the substrate after the drying in order to form at least one of the first reaction layer and the second reaction layer.

4. The method of manufacturing a fuel cell according to claim 1, further comprising:
firstly applying a droplet of the catalytic solution to the substrate; and
secondly applying a droplet of the catalytic solution that has a different size from the droplet firstly applied in order to form at least one of the first reaction layer and the second reaction layer.
